(19) United States
(12) Patent Application Publication
(10) Pub. No.: US 2024/0016206 A1
(43) Pub. Date: Jan. 18, 2024

(54) REDUCED ODOR SMOKING SYSTEM AND METHOD

(71) Applicant: Jawid Wahidi, Irvine, CA (US)

(72) Inventor: Jawid Wahidi, Irvine, CA (US)

(73) Assignee: AIDEMAR GROUP, INC., VERNON, CA (US)

(21) Appl. No.: 17/863,203

(22) Filed: Jul. 12, 2022

(51) Int. Cl. A24F 13/06; A24F 13/12; A24F 7/00; A24F 3/00; B03C 3/011; B03C 3/017; B01D 46/00; A24F 1/30; A24F 13/00; A24F 13/08

(52) U.S. Cl. CPC A24F 13/06; A24F 13/12; A24F 7/00; A24F 3/00; B03C 3/011; B03C 3/017; B01D 46/0038; B01D 46/0032; A24F 1/30; A24F 13/00; A24F 13/08

(57) ABSTRACT

A reduced odor smoking system and method is provided. The system designed to process smoke exhaled during the smoking of a smokeable material (such as a cigarette or waterpipe) to remove the smoke odor. The system includes a holder that holds smokeable material for ignition, and a system that processes the exhaled smoke to reduce the odor. During use, the user inhales smoke from the system and subsequently exhales the smoke back into the system to be processed. A valve assembly directs the smoke from the holder to the user's mouth during inhalation and from the user's mouth to the smoke processing system during exhalation. In this way, a user may enjoy smoking while minimizing the smoke odor (e.g., indoors).

### FIELD OF THE INVENTION

This invention relates to smoking devices, including smoking devices that reduce the odor of the resulting smoke.

### BACKGROUND

Smoking cigarettes and other smokeable materials is common throughout the world. However, the odor caused by the exhaled smoke is oftentimes unwelcomed by non-smokers, especially in indoor settings.

Accordingly, there is a need for reduced odor smoking system and method.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows a diagram of a reduced odor smoking system according to exemplary embodiments hereof;

FIG. 2 shows a reduced odor smoking system according to exemplary embodiments hereof; and

FIG. 3 shows a side sectional view of the reduced odor smoking system of FIG. 2 according to exemplary embodiments hereof.

FIG. 4 shows a schematic of a reduced odor smoking system according to exemplary embodiments hereof;

FIG. 5 shows a side sectional view of the reduced odor smoking system of FIG. 4 according to exemplary embodiments hereof;

FIG. 6 shows an exploded view of the reduced odor smoking system of FIG. 4 according to exemplary embodiments hereof;

FIG. 7 shows aspects of a combustion assembly according to exemplary embodiments hereof; and

FIG. 8 shows aspects of a smoke filter according to exemplary embodiments hereof; and

FIGS. 9-14 show alternative embodiments of the reduced odor smoking system according to exemplary embodiments hereof.

### DETAILED DESCRIPTION OF EXEMPLARY EMBODIMENTS

In general, the reduced odor smoking system and method according to exemplary embodiments hereof includes a system designed to process smoke exhaled during the smoking of a smokeable material. The system includes a smoking device that holds the smokable material while facilitating its ignition and subsequent combustion. The system also includes a smoke processing system that processes the exhaled smoke to reduce the smoke odor. During use, the user inhales smoke from the system and subsequently exhales the smoke back into the system to be processed. A valve assembly directs the smoke from a combustion element to the user's mouth and from the user's mouth to the smoke processing system. In this way, a user may enjoy smoking while minimizing the smoke odor (e.g., indoors).

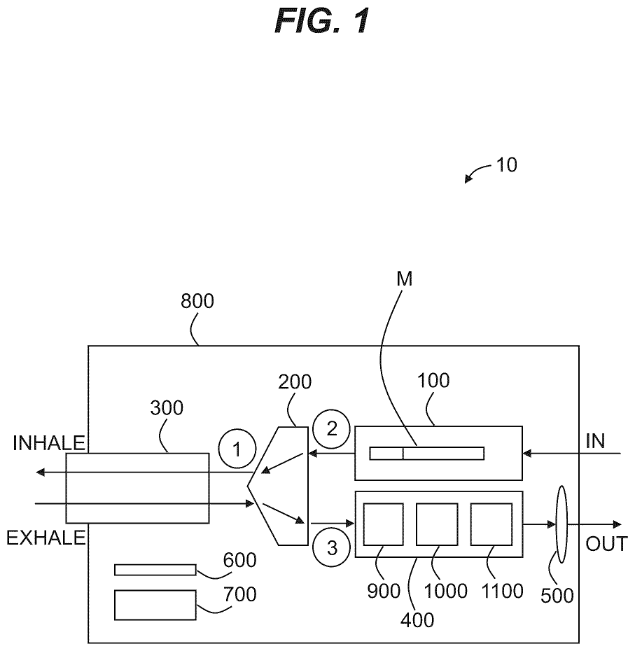

The reduced odor smoking system will be described in detail with reference to FIGS. 1-14. For the purposes of this specification, the reduced odor smoking system will be described primarily in relation to two main versions of the product: ( ) a handheld unit, and (ii) a waterpipe unit. However, it is understood that the reduced odor smoking system may be formed as any type of smoking device and that the scope of the system is not limited in any way by the type of smoking device it is incorporated with.

Handheld Unit

In one exemplary embodiment hereof, as shown in FIG. 1, the reduced odor smoking system 10 (also referred to herein as simply the system 10) includes a combustion assembly 100, a valve assembly 200, a mouthpiece assembly 300, smoke processing assembly 400, a fan assembly 500, a controller 600, a power source 700, and a housing assembly 800. The reduced odor smoking system 10 may include other elements as necessary to fulfill its functionalities.

In general, a smokable material M (e.g., a cigarette) is placed into the combustion assembly 100 and subsequently combusted to create smoke. The smoke passes through the valve assembly 200 and is inhaled by the user through the mouthpiece assembly 300. The user then exhales the smoke from his/her lungs back into the mouthpiece assembly 300 and the valve assembly 200 directs the exhaled smoke to the smoke processing assembly 400. As the smoke passes through the smoke processing assembly 400, the smoke is processed to remove unwanted odors and particulates. The processed smoke then passes through the fan assembly 500 and is discharged from the system 10. In this way, a user may smoke a smokable material M using the system 10 while creating little to no smoke and/or smoke odor (e.g., indoors).

The controller 600 controls the various elements of the system 10 and the power source 700 is configured to provide the system 10 the required power. The various assemblies are housed and protected within the housing assembly 800.

As will be described in other sections, the smoke processing assembly 400 includes a filter assembly 900, a negative ion assembly 1000, and an ozone assembly 1100.

FIG. 1 shows a generalized block diagram of the system 10. It is understood that the various assemblies 100, 200, 300, 400, 500, 600, 700, 800, 900, 1000, 1100 are represented as basic blocks for clarity, and that the blocks do not necessarily represent the size, shape, orientation, or positioning of the assemblies 100, 200, 300, 400, 500, 600, 700, 800, 900, 1000, 1100 (relative to other assemblies or in general).

In some embodiments, as shown in FIG. 1, the combustion assembly 100 is in fluid communication with the valve assembly 200 which is in fluid communication with mouthpiece assembly 300. In addition, the mouthpiece assembly 300 is in fluid communication with the valve assembly 200 which is in fluid communication with the smoke processing assembly 400 which is in fluid communication with the fan assembly 500.

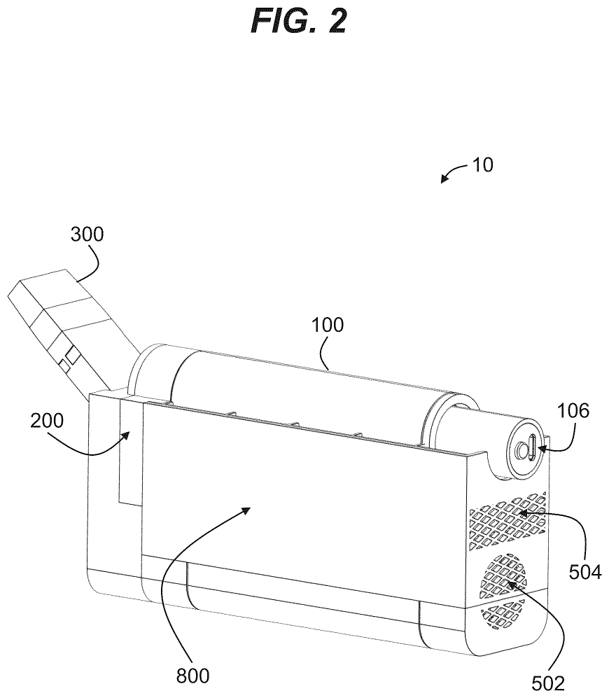

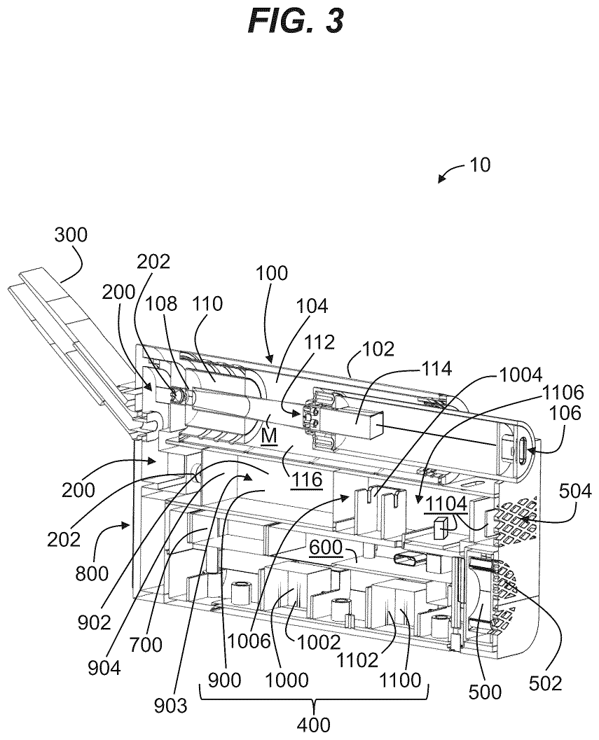

FIG. 2 shows an embodiment of the system 10 and FIG. 3 shows a side sectional view of the same.

Combustion Assembly 100 (Handheld Unit)

In some embodiments, as shown in FIG. 3, the combustion assembly 100 is adapted to receive a smokable material M (e.g., a cigarette or cone) and to ignite and support the smokable material M during use of the system 10.

In some embodiments, the combustion assembly 100 includes a chamber housing 102 with an internal compartment 104 adapted to receive and support the smokable material M. The chamber housing 102 and internal compartment 104 include an air inlet 106 at a first end (e.g., the right end as shown in FIG. 3) enabling air (including oxygen) to enter the compartment 104 to facilitate the combustion of the smokable material M. The chamber housing 102 and compartment 104 also include an outlet 108 at a second end (e.g., the left end as shown in FIG. 3) through which smoke resulting from the combustion of the smokable material M may exit the combustion assembly 100 to pass through the valve assembly 200 and mouthpiece assembly 300 to be inhaled by the user.

While the combustion assembly 100 is depicted as being generally located at the top portion of the system 10 in FIG. 3, it is understood that the combustion assembly 100 may be located at any portion of the system 10 (e.g., on the side, middle, bottom, etc.).

The combustion assembly 100 preferably is airtight during use so that smoke may not leak to outside the assembly 100 while the system 10 is in use.

In some embodiments as shown in FIG. 3, the combustion chamber 102 is generally cylindrical with a generally circular cross section. However, it is understood that the chamber 102 may include any suitable shape, form, and/or cross-sectional shape (e.g., cuboid).

In some embodiments, a portion of the chamber housing 102 is able to open to allow the insertion of the smokable material M into the chamber 102. For example, the chamber housing 102 may include a top, side, and/or end panel that is rotatably opened/closed, that is slidably opened/closed, that is removable, and/or that may be adjusted in any way to enable the insertion of the material M.

In some embodiments, the compartment 104 includes a tray, cradle, channel, or other type of holding structure upon which the smokable material M may be placed for support. In some embodiments, the tray may be fixed in place while in other embodiments the tray may be removeable. For example, in some embodiments, the tray may be removed through an open top panel or slide out the right end via a spring-loaded mechanism to facilitate the loading of the smokable material M.

In some embodiments, as shown in FIG. 3, the combustion assembly 100 includes a smokable material support structure 110 adapted to support the smokable material M during combustion of the material M. In some embodiments, the smokable material support structure 110 includes a cylindrical structure with an inner longitudinal channel (e.g., tubular, ring, or donut-shaped) positioned toward the outlet 108 at the second end (e.g., the left end as shown in FIG. 3). The tubular structure includes an open end adapted to receive and secure a mouth end (e.g., the filter end or insert end) of a cigarette, cone, or other type of smokable rod (as shown). In some embodiments, the smokable material support structure 110 is removeable and may be removed to be configured with the smokable rod and then placed back into the compartment 104 for use. In other embodiments, the smokable material support structure 110 may pivot upward to receive the mouth end of the smokable rod, and in other embodiments, the support structure 110 may be fixed.

In some embodiments, as shown in FIG. 3, the combustion assembly 100 includes an ignition device 112 adapted to ignite the ignitable end (i.e., the end opposite the filter or insert) of a cigarette, cone, or other smokable rod. The ignition device 112 may include a heating element that converts electrical energy into heat through the process of Joule heating wherein electric current passing through the element encounters resistance, resulting in heating of the element. In some embodiments, the heating element may include a metal heating element, a ceramic and semiconductor heating element, a thick film heating element, a polymer PTC heating element, a composite heating element, and/or other suitable types of heating elements. It is understood that other types of ignition devices 112 also may be used and that the scope of the system 10 is not limited in any way by the type(s) of ignition devices utilized. For example, ignition devices 112 including flames (e.g., butane), torches, and other types of devices also are contemplated.

In some embodiments, the ignition device 112 is turned on or otherwise triggered to ignite the smokable material M by an activation device (e.g., a mechanical and/or an electronic button).

As is known in the art, many cigarettes (such as fire safe cigarettes (FSCs)) are designed to self-extinguish unless the user periodically intensifies the flame by inhaling (e.g., if the user places the cigarette down while it is still burning the cigarette will self-extinguish). These types of cigarettes are designed to prevent accidental fires in households and in other areas. Accordingly, in some embodiments, as shown in FIG. 3, the ignition device 112 may be coupled with a tension mechanism 114 adapted to apply constant tension between the lit end of the smokable rod and the ignition device 112. In this way, heat is continually applied to the smokable rod such that it may not quickly self-extinguish even if the user pauses his/her inhalation. Given that the smokable rod is combusted only while secured within the combustion 100, the chance of an accidental fire is eliminated. In some embodiments, the tension mechanism 114 includes a spring and/or other type(s) of tensioning devices.

In some embodiments, the ignition device 112 is configured to translate longitudinally (e.g., to the left in FIG. 3 due to the force applied to it by the tension mechanism 114) in order to remain abutted with the lit end of the smokable rod as the rod burns. In this way, as the smokable rod burns and its length diminishes, the ignition device 112 may translate (e.g., to the left in FIG. 3) to remain in contact with the lit end of the smokable. In some embodiments, the ignition device 112 may translate along a guide, rail, track, channel, other types of guide structures, and any combinations thereof.

For example, in some embodiments, the tension mechanism 114 includes a preloaded spring configured between the backside of the ignition device 112 and a suitable structure generally opposite the backside of the ignition device 112 (e.g., the right end of the compartment 104 towards the inlet 106 in FIG. 3). In this way, the tension mechanism 114 may provide a continual force to the ignition device 112 thereby pressing it against the lit end of the smokable rod and causing the ignition device 112 to translate (e.g., to the left in FIG. 3) as the smokable rod burns and its length decreases. It is understood that other types of tension mechanisms 114 also may be used.

It also is contemplated that the tension mechanism 114 be configured to apply a force to the support structure 110 and/or the smokable rod in a direction toward the ignition device 112 in order to keep the lit end of the rod in contact with the ignition device 112. It also is contemplated that the support structure 110 and/or the smokable rod be adapted to translate toward the ignition device 112 as the smokable rod burns and diminishes in length in order to maintain contact.

In some embodiments, the combustion assembly 100 includes an ash catcher 116 (e.g., a channel or cavity) configured below the burning smokable rod in order to catch and hold any ash that may fall from the burning rod.

In some embodiments, the combustion assembly 100 is designed to receive and secure other types of smokable materials (e.g., other than smokable rods such as cigarettes and/or cones). For example, in some embodiments, the combustion assembly 100 includes a bowl or dish configured to receive smokable flower material (e.g., cannabis) and to facilitate the igniting and smoking of the material. In another example, the combustion assembly 100 includes a banger (a dish) configured to receive smokable concentrates (e.g., cannabis concentrate or dabs) and to facilitate the combustion and/or vaporization of the concentrate. In another example, the combustion assembly 100 includes a vape cartridge holder adapted to receive and provide adequate power to the cartridge to cause the vaporization of the oil within the cartridge. It is understood that the combustion assembly 100 may be configured to facilitate the combustion and/or vaporization of any type of smokeable material M and that the scope of the system 10 is not limited in any way by the type of smokeable material M it is configured to utilize.

Valve Assembly 200 (Handheld Unit)

In some embodiments, as shown in FIG. 3, the valve assembly 200 is configured between the outlet 108 of the combustion assembly 100 and the mouthpiece assembly 300, and between the mouthpiece assembly 300 and the smoke processing assembly 400. The valve assembly 200 is adapted to direct smoke from the combustion assembly 100 to the mouthpiece assembly 300 for inhalation of the smoke, and to direct subsequently exhaled smoke from the mouthpiece assembly 300 to the smoke processing assembly 400.

In some embodiments, as shown in FIG. 1, the valve assembly 200 may generally include three ports (1), (2), and (3). As shown, the valve assembly 300 provides two paths through the assembly 200. A first path (2)-(1) is a path for smoke to travel from the combustion assembly 100 to the mouthpiece assembly 300, and a second path (1)-(3) is a path for exhaled smoke to travel from the mouthpiece assembly 300 to the smoke processing assembly 400. It is preferred that the path (2)-(3) include high isolation so that no smoke travels between the combustion assembly 100 and the smoke processing assembly 400, and vice versa.

In some embodiments, the valve assembly 200 includes two or more one-way valves 202 (e.g., duck valves). For example, a first one-way valve 202 may be configured between the outlet 108 of the combustion assembly 100 and the mouthpiece assembly 300 and configured to only allow smoke to travel in this direction. In this way, the smoke is prevented from traveling from the mouthpiece assembly 300 back to the combustion assembly 100. In addition, a second one-way valve 202 may be configured between the mouthpiece assembly 300 and the smoke processing assembly 400 and configured to only allow smoke to travel in this direction. In this way, the smoke is prevented from traveling from the smoke processing assembly 400 back to the mouthpiece assembly 300. It is understood that any types of suitable one-way valves 202 may be used. Notably, no manual intervention may be required for use of this type of valve assembly 200.

In some embodiments, the valve assembly 200 includes a manual mechanism to reconfigure the valve assembly 200 from the first path (2)-(1) to the second path (1)-(3). That is, the valve assembly 200 may include a push button, slider, knob, switch, and/or other type of control mechanism(s) that when activated changes the active path through the valve assembly 200 from the first path (2)-(1) (for inhaling smoke) to the second path (1)-(3) (for exhaling smoke) and back again as required during use. In some embodiments, the switch assembly 200 may be manually activated to change paths while in other embodiments the valve assembly 200 may include an electric actuator that causes the valve assembly 200 to change paths when instructed (e.g., by a button).

It is understood that any type of adequate valve assembly 200 that performs the functionality as described above may be used by the system 10.

Mouthpiece Assembly 300 (Handheld Unit)

In some embodiments, as shown in FIGS. 2 and 3, the mouthpiece assembly 300 includes a mouthpiece section 302 designed to guide the smoke from the valve assembly 200 to the user's mouth for inhalation and from the user's mouth back to the valve assembly 200 after exhalation. The mouthpiece section 302 preferably includes a duct-like structure with outer sidewalls and an inner longitudinal channel passing through the section 302 through which the smoke may travel. The mouthpiece section 302 preferably is airtight so that smoke may not leak to outside the mouthpiece assembly 300 when in passing through the section 302.

In some embodiments, the mouthpiece section 302 is telescopic so that it may be expanded for use and retracted for stowage.

In some embodiments, the proximal end of the mouthpiece section 302 is rotatably mounted to the housing assembly 800 so that the angle of the mouthpiece section 302 with respect to the housing assembly 800 may be adjusted. In some embodiments, the mouthpiece section 302 may be pivoted to be at least somewhat flush with the housing assembly 800 for stowage when not in use and subsequently rotated outward for use. In some embodiments, the housing assembly 800 may include a side stowage cavity to receive the mouthpiece section 302 when rotated inward for stowage.

In some embodiments, the mouthpiece section 302 is removable (e.g., for cleaning) and replaceable.

In some embodiments, the mouthpiece section 302 may simply comprise an opening in the side of the housing assembly 800. For use, the user may place his/her mouth over the opening to inhale and exhale the smoke.

Smoke Processing Assembly 400 (Handheld Unit)

In some embodiments, smoke exhaled from the user passing through the valve assembly 200 from the mouthpiece assembly 300 enters and passes through the smoke processing assembly 400 on its way to the fan assembly 500. As the smoke passes through the smoke processing assembly 400, the smoke is filtered, purified, and/or otherwise processed to reduce the smoke, smoke particulates, and smoke odor prior to being discharged from the system 10.

In some embodiments, as shown in FIG. 3, the smoke processing assembly 400 includes a filter assembly 900, a negative ion assembly 1000, and an ozone assembly 1100.

In some embodiments, the filter assembly 900 includes one or more filters 902 comprising filter materials 904 designed to filter out particulates and other odor causing elements from the exhaled smoke. The materials 904 are preferably chosen to include a high filtration efficiency. In some embodiments, the filter materials 904 includes a bulk of cotton, cellulose acetate, paper, rayon, hemp, corn husk, foam, other suitable filtration materials, and any combinations thereof. In some embodiments, the filters 902 include alternating layers of various filter materials 904, such as, without limitation, foam, cotton, foam, cotton, and so on.

In some embodiments, the filter material(s) 904 are preferably formed into a three-dimensional shape (e.g., cuboid, cylindrical, etc.) and positioned within a filter compartment 903 within the system housing assembly 800 designed to receive and support the filter material 904. In this way, as will be described in other sections, the housing 800 may be opened and the filter assembly 900, filters 902, and/or materials 904 may be removed, replaced, cleaned, etc. as required.

In some embodiments, as shown in FIG. 3, the filter compartment 903 is located adjacent the valve assembly 200 so that exhaled smoke from the mouthpiece section 302 passing through the valve assembly 200 into the smoke processing assembly 400 enters directly into the filter compartment 903. In this way, the smoke then passes through the filter assembly 900 filter material 904 and is filtered.

In some embodiments, the filter material may be held within a filter material holder (e.g., a casing) that may be held within a compartment within the housing assembly 800.

In some embodiments, the smoke processing assembly 400 includes a negative ion assembly 1000 adapted to produce and utilize negative ions to remove particulates and odor from the exhaled smoke.

As is known in the art, negative ions tend to attach themselves to particulates in the air thereby giving the particulates a negative charge. This negative charge then causes the particulates to attract and attach to other particulates and/or to earthed (grounded) conductors or structures, either deliberate structures within the system 10 (e.g., within the filter assembly 900 and/or housing 800) or otherwise. In some cases, the particulates continue to clump together until the weight of the mass causes it to precipitate out of the air (that is, the newly formed larger particles become too heavy to remain suspended in the air).

In some embodiments, as shown in FIG. 3, the negative ion assembly 1000 includes one or more negative ion generation devices 1002. In some embodiments, the negative ion generation devices 1002 use high voltage to ionize (electrically charge) air molecules. In other embodiments, the negative ion generation devices 1002 include electrostatic discharge (ESD) ionizers, other types of negative ion generation devices, and/or any combinations thereof.

In some embodiments, as shown in FIG. 3, the negative ion generation devices 1002 release negative ions via negative ion emitters 1004 positioned to release the negative ions within a negative ion chamber 1006. In some embodiments, the chamber 1006 is located adjacent the filter compartment 903 so that smoke passing through the filter assembly 900 is subsequently (or simultaneously) introduced to the ions. In other embodiments, the negative ion emitters 1004 are configured to release the ions directly into the filter compartment 903 and/or into other areas within the system 10.

In some embodiments, the smoke processing assembly 400 includes an ozone assembly 1100 adapted to produce and utilize ozone to remove odor from the exhaled smoke.

As is known in the art, ozone (O₃) is a reactive molecule that provides an oxygen atom to odor causing molecules that it comes into contact with. The added oxygen atom changes the chemical makeup of the odor causing molecule to remove the odor. Accordingly, by combining ozone with the exhaled smoke, the ozone reacts to reduce the smoke odor.

In some embodiments, as shown in FIG. 3, the ozone assembly 1100 includes one or more ozone generation devices 1102. In some embodiments, the ozone generation devices 1102 include a corona discharge ozone generation device, an ultraviolet light ozone generation device, other suitable types of ozone generation devices, and any combinations thereof.

In some embodiments, as shown in FIG. 3, the ozone generation devices 1102 release ozone via ozone emitters 1104 positioned to release ozone within an ozone chamber 1106 and/or to expel ozone out of the housing 800 via an outlet 504. In some embodiments, the chamber 1106 is located adjacent the negative ion chamber 1006 and/or the filter compartment 903 so that smoke passing through the negative ion assembly 1000 and/or the filter assembly 900 is subsequently (or simultaneously) introduced to the ozone. In other embodiments, the ozone emitters 1104 are configured to release the ions directly into the filter compartment 903, into the negative ion compartment 1006, and/or into other areas within the system 10.

In some embodiments, as shown in FIG. 3, the outlet 504 is positioned adjacent the fan assembly 500 and its outlet 502 (e.g., above the fan assembly outlet 502) so that the fan assembly 500 may cause the ozone from the emitters 1104 and the purified smoke from the overall system 10 to be mixed together upon release from the housing 800. In this way, the area immediately outside the outlets 502, 504 may contain ozone thereby further removing the smoke odor in this area.

It is understood that the locations of the filter assembly 900, the negative ion assembly 1000, and the ozone assembly 1100 may be rearranged within the housing 800 in any order.

Fan Assembly 500 (Handheld Unit)

In some embodiments, as shown in FIGS. 1 and 3, the fan assembly 500 includes any suitable type(s) of air moving mechanism(s) (e.g., one or more fans). In some embodiments, the fan assembly 500 is configured to receive processed smoke from the smoke processing assembly 400 and to discharge the smoke out of the housing assembly 800 via a fan outlet 502 (e.g., a gridded outlet as shown in FIG. 3).

Controller 600 (Handheld Unit)

In some embodiments, the controller 600 includes any type of suitable controller including, but not limited to, a microcontroller, a microprocessor, a CPU, RAM memory, a circuit board, and any other type of component necessary for the functionality of the controller 600.

In some embodiments, the controller 600 is designed and configured to electronically control various assemblies and/or elements of the system 10, such as, without limitation, the ignition device 112, the ozone assembly 1000, the negative ion assembly 1100, the fan assembly 500, the valve assembly 200, the power source 700, other elements of the system 10 that may benefit from being electronically controlled, and any combinations thereof.

Power Source 700 (Handheld Unit)

In some embodiments, the power source 700 includes any type of adequate power source to power the various electronic assemblies and/or elements of the system 10, such as, without limitation, the ignition device 112, the ozone assembly 1000, the negative ion assembly 1100, the fan assembly 500, the valve assembly 200, the controller 600, other elements of the system 10 that may benefit from being powered, and any combinations thereof.

In some embodiments, the power source 700 includes a rechargeable power source (e.g., a rechargeable battery or rechargeable battery pack) so that the power source 700 may be plugged into an external recharging device (e.g., an electrical wall outlet) to be recharged.

In some embodiments, the power source 700 is removable and may be replaced as necessary.

It is understood that the power source 700 may include any adequate power source adapted to adequately power the assemblies and elements of the system 10 that would benefit from being powered.

Housing Assembly 800 (Handheld Unit)

In some embodiments, as shown in FIG. 3, the housing assembly 800 includes an outer casing defining an inner volume adapted to receive, house, and secure the various assemblies and elements of the system 10.

In some embodiments, the housing assembly 800 includes one or more internal cavities, with each internal cavity designed to receive and house a particular assembly or element of the system 10.

In some embodiments, the housing assembly 800 may open to allow access to at least some of the assemblies and/or elements of the system 10 so that the assemblies and/or elements may be removed, maintained, cleaned, and/or replaced. In this way, the system 10 is modular. For example, in some embodiments, a lower portion, upper portion, and/or side portion of the housing assembly 800 may be removable (and/or pivotable away from the housing) to allow access to the filter assembly 900, the ozone assembly 1000, and/or the negative ion assembly 1100, as these assemblies may require maintenance, cleaning, removal, replacement, etc.

In some embodiments, the filter compartment 903, the negative ion 1006, and/or the ozone chamber 1106 may be combined into a single smoke processing chamber or into two or more chambers.

In Use (Handheld Unit)

To use the system 10, a user and/or the system 10 may take at least some of the following actions:

The user powers on the system 10, opens the combustion assembly 100, and inserts a smokeable material M (e.g., a smokeable rod) into the combustion compartment 104. This may include removing a smokeable material support structure 110 and configuring it with the smokeable rod, and/or simply placing the mouth end of the smokeable rod into the support structure 110 within the compartment 104.

The user and/or the system 10 then arranges the ignition device 112 to contact the light-able end of the smokeable rod. The system 10 then applies tension (a force) to the ignition device 112 so that it remains in physical contact with this end of the smokeable rod as the rod burns and diminishes in length.

The user and/or the system 10 activates the ignition device to ignite the end of the smokeable rod to cause combustion of the smokeable material.

The user inhales through the mouthpiece assembly 300.

Simultaneously or prior to the user's inhalation, the user and/or the system 10 configures the valve assembly 200 to activate the (2)-(1) path. Note that this may or may not require manual intervention from the user depending on the type of valve assembly 200 utilized as described herein.

Smoke from the combustion assembly 100 passes through the valve assembly 200 and into the user's lungs.

The user exhales smoke into mouthpiece assembly 300.

Simultaneously or prior to the user's exhalation, the user and/or the system 10 configures the valve assembly 200 to activate the (1)-(3) path. Note that this may or may not require manual intervention from the user depending on the type of valve assembly 200 utilized as described herein.

Exhaled smoke passes into and through the smoke processing assembly 400 and is processed as described herein and discharged out of the system 10 by the fan assembly 500.

It is understood that the actions described above are meant for demonstration and that not all of the action may be required, that other actions may be taken, and that the actions may be taken in different order.

It is understood that any aspect and/or element of any embodiment of the system 10 described herein or otherwise may be combined with any other aspect and/or element of any other embodiment described herein or otherwise in any way to form additional embodiments of the system 10 all of which are within the scope of the system 10.

Waterpipe Unit

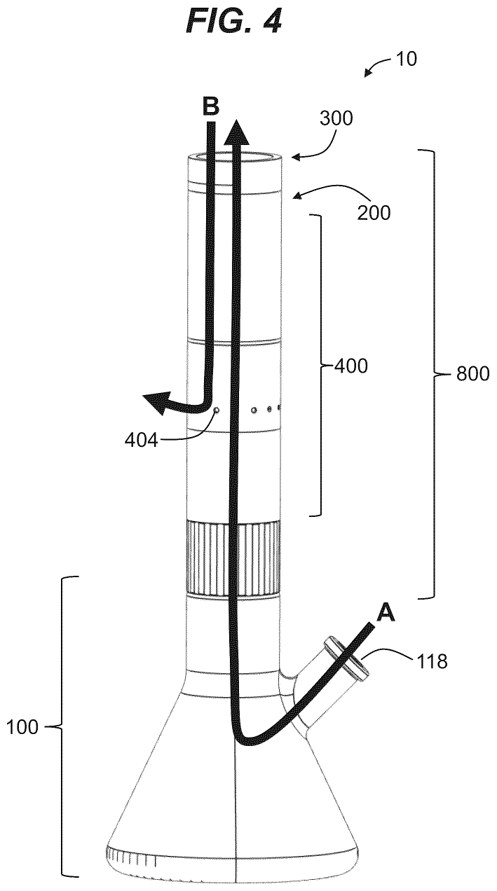

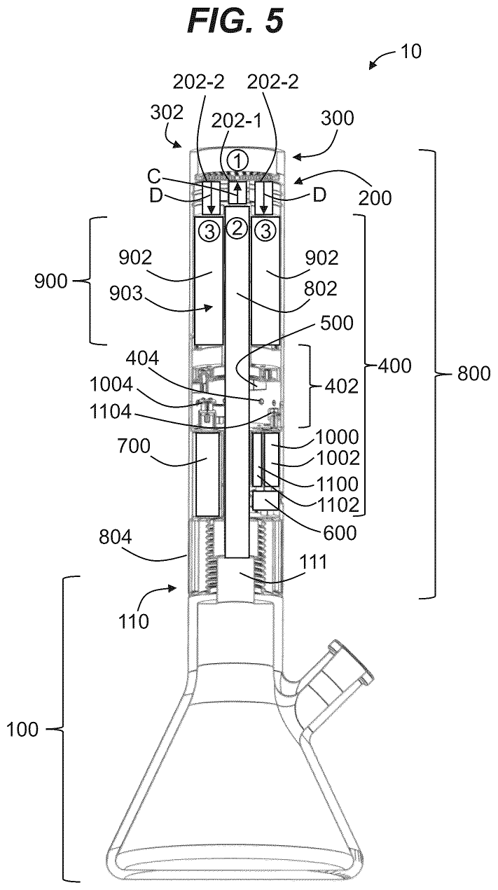

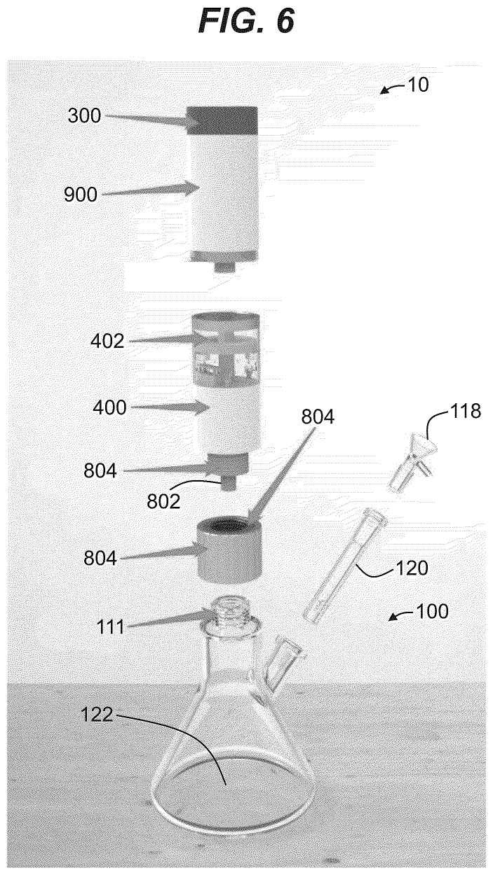

FIG. 4 shows an embodiment of the system 10 and FIG. 5 shows a side sectional view of the same. FIG. 6 shows an exploded view of the system 10.

In one exemplary embodiment hereof, as shown in FIGS. 4-5, the reduced odor smoking system 10 (also referred to herein as simply the system 10) includes a combustion assembly 100, a valve assembly 200, a mouthpiece assembly 300, a smoke processing assembly 400, a fan assembly 500, a controller 600, a power source 700, and a housing assembly 800. The reduced odor smoking system 10 may include other elements as necessary to fulfill its functionalities.

In general, as shown in FIG. 4, a smokable material M (e.g., cannabis) is placed into the combustion assembly 100 (e.g., the bowl piece 118) and subsequently combusted to create smoke. The smoke passes from the combustion assembly 100 through an upright passageway in the housing assembly 800 to the valve assembly 200 and is subsequently inhaled by the user through the mouthpiece assembly 300. The user then exhales the smoke from his/her lungs back into the mouthpiece assembly 300 and the valve assembly 200 directs the exhaled smoke to the smoke processing assembly 400. As the smoke passes through the smoke processing assembly 400, the smoke is processed to remove unwanted odors and particulates. The processed smoke is then discharged from the system 10 through one or more outlets 404.

Accordingly, as shown in FIG. 4, there are generally two fluid paths through the system 10. A first path A (also referred to as the inhalation path) extends from the combustion assembly 100, through the valve assembly 200, and out the mouthpiece assembly 300 (and to the user's mouth). The second path B (also referred to as the exhalation path) extends from the mouthpiece assembly 300, through the valve assembly 200, through the smoke processing assembly 400, and out the outlets 404. In this way, the user may inhale smoke via path A and exhale smoke (to be processed by the system 10) via path B.

In some embodiments, as shown in FIG. 4, in the first path A (the inhalation path) the combustion assembly 100 is in fluid communication with the valve assembly 200 via an upright passageway 802 (see FIG. 5) through the system's housing assembly 800 (preferably centered) and the valve assembly 200 is in fluid communication with mouthpiece assembly 300. In the second path B (the exhalation path), the mouthpiece assembly 300 is in fluid communication with the valve assembly 200 which is in fluid communication with the smoke processing assembly 400.

As will be described in other sections, the smoke processing assembly 400 includes a filter assembly 900, a negative ion assembly 1000, and an ozone assembly 1100. The smoke processing assembly 400 also includes a processing chamber 402 within which the smoke may be processed along with output elements 404 (e.g., vent holes) to release the processed smoke from the system 10.

The controller 600 controls the various elements of the system 10 and the power source 700 is configured to provide the system 10 the required power. The various assemblies (except possibly the combustion assembly 100) are housed and protected within the housing assembly 800.

Combustion Assembly 100 (Waterpipe Unit)

In some embodiments, as shown in FIGS. 4 and 6, the combustion assembly 100 includes a bowl piece 118 (see FIG. 3) adapted to receive and support a smokable material M (e.g., cannabis) during combustion and a downstem 120 (see FIG. 3) that leads from the bowl piece 118 into a water chamber 122. As known in the art, as the smokable material M is combusted in the bowl piece 118 and the user inhales, the smoke travels from the bowl piece 118 down the down stem 120, through the water in the water chamber 122 and up through the top of the assembly 100 and ultimately to the mouthpiece 300. The bowl piece 118, downstem 120, and water chamber 122 may comprise glass, plastic, ceramic, silicone, metal, wood, other suitable materials, and any combinations thereof.

In some embodiments, as shown in FIGS. 5-7, the upper portion of the water chamber 122 includes a coupler 110 adapted to removably attach the combustion assembly 100 to the housing assembly 800 (that houses the various other assemblies, e.g., 200, 300, 400, 600, 700, 800).

In some embodiments, as shown in FIGS. 5-6, the coupler 110 includes a flange 111 adapted to be received and attached to a corresponding flange 804 on the bottom portion of the housing 800. In some embodiments, the flanges 111, 804 may couple with one another via inner/outer threads (so that the waterpipe assembly 100 and the housing assembly 800 may be screwed together), detents, pressure fit, latches, gravity, other types of releasable attachment mechanisms, and any combinations thereof.

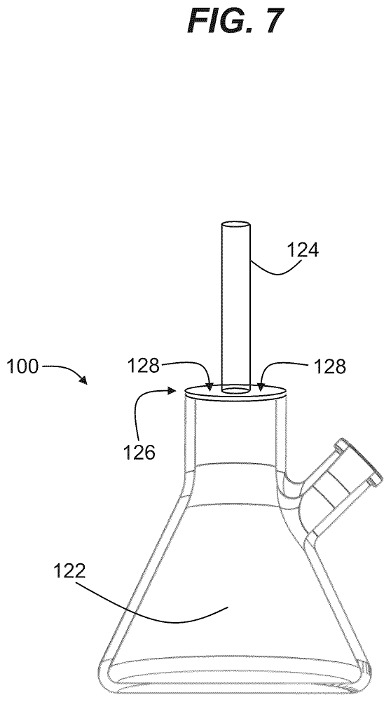

In some embodiments, as shown in FIG. 7, the combustion assembly 100 includes a top sidewall 126 that generally forms a top to the water chamber 122. In this scenario, the coupler 110 is at least partially formed by a topside circumferential ledge 128 (formed by the top sidewall 126) and an upright tube 124 generally centered on and extending upward from the circumferential ledge 128. The upright tube 124 extends through the top sidewall 126 so that the tube 124 and the water chamber 122 are in fluid communication. The upright tube 124 is adapted to extend into and through at least a portion of the upright passageway 802 as the housing 800 rests on the ledge 128. In this way, the upright tube 124 provides lateral support to the housing assembly 800 while providing a fluid path between the combustion assembly 100 and the upright passageway 802. It is preferred that the junction of the upright tube 124 and the upright passageway 802 be generally airtight when the housing 800 is resting on the ledge 128 for use of the system 10.

In any event, it is understood that the coupler 110 provides a releasable airtight junction between the combustion assembly 100 and the housing 800. In this way, the housing 800 may be removed from the combustion assembly 100 so that either assembly 800, 100 may be cleaned, replaced, refurbished, maintained, interchanged, otherwise removed and/or replaced, and any combinations thereof.

With the combustion assembly 100 coupled to the housing 800, as the user inhales and as smokable material M is combusted in the bowl piece 118, smoke passes from the bowl piece 118 through the downstem 120 and through the water within the water chamber 122 (during which the smoke is filtered and cooled by the water). The smoke then passes upward through the coupler 110, into the housing 800, through the upright passageway 802, and through the valve assembly 200 after which it is inhaled by the user through the mouthpiece assembly 300.

The path from the bowl piece 118 through the downstem 120 through the water chamber 122 through the upright passageway 802 and through the valve assembly 200 is preferably airtight so that smoke may not leak to outside the system 10 during use.

In another example, the bowl piece 118 includes a banger (e.g., a dish) configured to receive smokable concentrates (e.g., cannabis concentrate or dabs) and to facilitate the combustion and/or vaporization of the concentrate. In another example, the combustion assembly 100 includes a vape cartridge holder adapted to receive and provide adequate power to the cartridge to cause the vaporization of the oil within the cartridge. It is understood that the combustion assembly 100 may be configured to facilitate the combustion and/or vaporization of any type of smokeable material M using any type of combustion/vaporization method and that the scope of the system 10 is not limited in any way by the type of smokeable material M it is configured to utilize.

Valve Assembly 200 (Waterpipe Unit)

In some embodiments, as shown in FIGS. 4-6, the valve assembly 200 is configured between the upper end of the upright passageway 802 and the mouthpiece assembly 300, and between the mouthpiece assembly 300 and the smoke processing assembly 400. The valve assembly 200 is adapted to direct smoke from the combustion assembly 100 to the mouthpiece assembly 300 for inhalation of the smoke, and to direct subsequently exhaled smoke from the mouthpiece assembly 300 to the smoke processing assembly 400 to be purified and discharged from the system 10.

In some embodiments, as shown in FIG. 5, the valve assembly 200 may generally include three ports (1), (2), and (3). As shown, the valve assembly 300 provides two paths through the assembly 200. A first path (2)-(1) (in the direction of the arrow C) is a path for smoke to travel from the combustion assembly 100 to the mouthpiece assembly 300, and a second path (1)-(3) (in the direction of the arrow D) is a path for exhaled smoke to travel from the mouthpiece assembly 300 to the smoke processing assembly 400. It is preferred that the path (2)-(3) include high isolation so that no smoke travels between the combustion assembly 100 and the smoke processing assembly 400, and vice versa.

In some embodiments, as shown in FIG. 5, the valve assembly 200 includes two or more one-way valves 202 (e.g., duck valves). It is understood that any type(s) of suitable one-way valve(s) may be used.

In some embodiments, a first one-way valve 202-1 may be configured between the upper outlet of the upright passageway 802 and the mouthpiece assembly 300 and configured to only allow smoke to travel in the direction indicated by the arrow C (along the inhalation path A). This arrangement accomplishes several objectives:
1. Only smoke generated at the combustion assembly 100 may pass through the first one-way valve 202-1 (in the direction of the arrow C) and out of the top of the mouthpiece assembly 300 to the user.
2. Smoke exhaled by the user into the mouthpiece assembly 300 may not pass through the one-way valve 202-1 (in the direction opposite of the arrow C) back towards the combustion assembly 100.

In some embodiments, a second one-way valve 202-2 may be configured between the mouthpiece assembly 300 and the smoke processing assembly 400 and configured to only allow smoke to travel in the direction indicated by the arrow D (along the exhalation path B). This arrangement accomplishes several objectives:
1. Only smoke exhaled by the user may pass through the second one-way valve 202-2 (in the direction of the arrow D) and into the smoke processing assembly 400.
2. Once the exhaled smoke has passed through the one-way valve 202-2 into the smoke processing assembly 400, it may not escape back up through the valve 202-2 (in the direction opposite to the arrow D) and out the mouthpiece assembly 300.
3. Purification elements residing within the smoke processing assembly 400 (e.g., ozone and negative ions) may not pass upward through the second one-way valve 202-2 (in the direction opposite to the arrow D) to the user.

Notably, no manual intervention may be required during use of valve assembly 200 embodiments that include one-way valves 202.

In some embodiments, the valve assembly 200 includes a manual mechanism to reconfigure the valve assembly 200 from the first path (2)-(1) to the second path (1)-(3). That is, the valve assembly 200 may include a push button, slider, knob, switch, and/or other type of control mechanism(s) that when activated changes the active path through the valve assembly 200 from the first path (2)-(1) (for inhaling smoke) to the second path (1)-(3) (for exhaling smoke) and back again as required during use. In some embodiments, the switch assembly 200 may be manually activated to change paths while in other embodiments the valve assembly 200 may include an electric actuator that causes the valve assembly 200 to change paths when instructed (e.g., by a button, by the controller 600, etc.).

It is understood that any type of adequate valve assembly 200 that performs the functionality as described above may be used by the system 10.

Mouthpiece Assembly 300 (Waterpipe Unit)

In some embodiments, as shown in FIG. 5, the mouthpiece assembly 300 includes a mouthpiece section 302 designed to guide the smoke from the valve assembly 200 to the user's mouth for inhalation and from the user's mouth back to the valve assembly 200 after exhalation. The mouthpiece section 302 preferably includes a duct-like structure with outer sidewalls and an inner longitudinal channel passing through the section 302 through which the smoke may travel. The mouthpiece section 302 preferably is airtight so that smoke may not leak to outside the mouthpiece assembly 300 when in passing through the section 302.

In some embodiments, the mouthpiece section 302 is removable (e.g., for cleaning) and replaceable.

In some embodiments, the mouthpiece section 302 may simply comprise an opening in the side of the housing assembly 800 and/or the valve assembly 200. For use, the user may place his/her mouth over the opening to inhale and exhale the smoke.

Smoke Processing Assembly 400 (Waterpipe Unit)

In some embodiments, exhaled smoke passing through the valve assembly 200 from the mouthpiece assembly 300 enters and passes through the smoke processing assembly 400. As the smoke passes through the smoke processing assembly 400, the smoke is filtered, purified, and/or otherwise processed to reduce the smoke, smoke particulates, and smoke odor prior to being discharged from the system 10.

In some embodiments, as shown in FIG. 5, the smoke processing assembly 400 includes a filter assembly 900, a negative ion assembly 1000, and an ozone assembly 1100. The smoke processing assembly 400 also includes a processing chamber 402 within which the smoke may be processed along with output elements 404 (e.g., vent holes) to release the processed smoke from the system 10.

In some embodiments, the filter assembly 900 includes one or more filters 902 designed to filter out particulates and other odor causing elements from the exhaled smoke. The filters 902 may include materials preferably chosen to include a high filtration efficiency. In some embodiments, the filter assembly 900 includes a bulk of cotton, cellulose acetate, paper, rayon, hemp, corn husk, other filtration materials, and any combinations thereof.

In some embodiments, as shown in FIG. 5, the filters 902 are positioned within a filter compartment 903 within the housing assembly 800. The filter compartment 903 may include an area within the housing 800 directly below the valve assembly 200 so that smoke exiting the valve assembly 200 may pass directly into the filter compartment 903 and through the filters 902 housed therein.

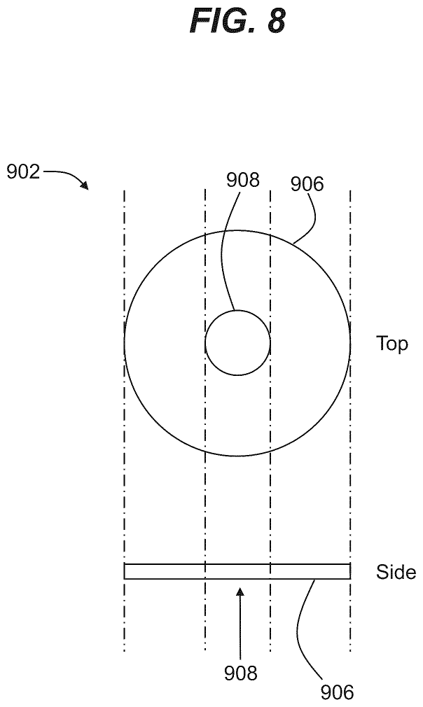

In some embodiments, as shown in FIG. 8, the filters 902 are preferably formed as discs 906, each with a center opening 908. The filters 902 may be concentrically stacked and positioned within the tubular housing 800. In some embodiments, the upright passageway 802 may extend through the center openings 908 of the stacked filters 902 from below the filter assembly 900 to above the filter assembly 900. In this way, the filters 902 may be in the exhalation path B within the tubular housing 800 and not in the inhalation path A. Being disc-shaped, the filters 902 maximize the usable filtering area around the upright passageway 802 while within the confines of the tubular housing 800.

In some embodiments, the housing 800 may be opened (e.g., the mouthpiece assembly 300 and/or the valve assembly 200 may be removed, e.g., pulled off from the top of the housing 800) thereby exposing the filters 902 and enabling them to be removed, replaced, cleaned, etc. as required. In other embodiments, the filters 902 may include other types of three-dimensional shapes (e.g., cuboid, cylindrical, etc.) and housed within a compartment within the housing assembly 800 designed to receive and support the filters 902.

In some embodiments, the filters 902 may be held within a filter holder (e.g., a cylindrical casing) that may be held within the housing assembly 800.

In some embodiments, the smoke processing chamber 402 is located directly below the filter assembly 900 so that smoke is first filtered by the filter assembly 900 and then further processed by the negative ion and ozone assemblies 1000, 1100 within the processing chamber 402 as described below.

In some embodiments, as shown in FIG. 5, the smoke processing assembly 400 includes a negative ion assembly 1000 adapted to produce and utilize negative ions to remove particulates and odor from the exhaled smoke.

As is known in the art, negative ions tend to attach themselves to particulates in the air thereby giving the particulates a negative charge. This negative charge then causes the particulates to attract and attach to other particulates and/or to earthed (grounded) conductors or structures, either deliberate structures within the system 10 (e.g., within the filter assembly 900 and/or the processing chamber 402) or otherwise. In some cases, the particulates continue to clump together until the weight of the mass causes it to precipitate out of the air (that is, the newly formed larger particles become too heavy to remain suspended in the air).

In some embodiments, as shown in FIG. 5, the negative ion assembly 1000 includes one or more negative ion generation devices 1002. In some embodiments, the negative ion generation devices 1002 use high voltage to ionize (electrically charge) air molecules. In other embodiments, the negative ion generation devices 1002 include electrostatic discharge (ESD) ionizers, other types of negative ion generation devices, and/or any combinations thereof.

In some embodiments, as shown in FIG. 5, the negative ion generation devices 1002 release negative ions via negative ion emitters 1004 positioned to release negative ions into the processing chamber 402. In some embodiments, the processing chamber 402 is located adjacent (e.g., below in FIG. 5) the filter compartment 903 so that smoke passing through the filter assembly 1000 is subsequently (or simultaneously) introduced to the negative ions. In other embodiments, the negative ion emitters 1004 are configured to release the ions directly into the filter compartment 903, and/or into other areas within the system 10.

In some embodiments, as shown in FIG. 5, the smoke processing assembly 400 includes an ozone assembly 1100 adapted to produce and utilize ozone to remove odor from the exhaled smoke.

As is known in the art, ozone (O₃) is a reactive molecule that provides an oxygen atom to odor causing molecules that it comes into contact with. The added oxygen atom changes the chemical makeup of the odor causing molecule to remove the odor. Accordingly, by combining ozone with the exhaled smoke, the ozone reacts to reduce the smoke odor.

In some embodiments, as shown in FIG. 5, the ozone assembly 1100 includes one or more ozone generation devices 1102. In some embodiments, the ozone generation devices 1102 include a corona discharge ozone generation device, an ultraviolet light ozone generation device, other suitable types of ozone generation devices, and any combinations thereof.

In some embodiments, as shown in FIG. 5, the ozone generation devices 1102 release ozone via ozone emitters 1104 positioned to release ozone into the processing chamber 402. In some embodiments, the processing chamber 402 is located adjacent (e.g., below in FIG. 5) the filter compartment 903 so that smoke passing through the filter assembly 900 is subsequently (or simultaneously) introduced to the ozone. In other embodiments, the ozone emitters 1104 are configured to release the ozone directly into the filter compartment 903, and/or into other areas within the system 10.

Notably, the upright passageway 802 extending between the combustion assembly 100 and the mouthpiece assembly 300 passes through the smoke processing chamber 402 and the filter assembly 900 while being isolated therefrom. That is, the upright passageway 802 includes sidewalls (it is tubular) that isolate smoke within the passageway 802 (flowing in the direction of the inhalation path B) from the effects of the smoke processing assembly 400 and the filter assembly 900. In this way, the inhaled smoke is generally unprocessed.

Fan Assembly 500 (Waterpipe Unit)

In some embodiments, as shown in FIG. 5, the system 10 includes a fan assembly 500 to help facilitate the expulsion of the processed smoke out of the processing chamber 402 through the vent holes 404. The fan assembly 500 may include any suitable type(s) of air moving mechanism(s) (e.g., one or more fans).

In some embodiments, the fan assembly 500 also facilitates the expulsion of ozone (released by the ozone emitters 1104) into the area immediately outside the system 10 (e.g., immediately outside the vent holes 404) such that this area also may contain ozone to further remove the smoke odor in this area.

Controller 600 (Waterpipe Unit)

In some embodiments, the controller 600 includes any type of suitable controller including, but not limited to, a microcontroller, a microprocessor, a CPU, RAM memory, a circuit board, and any other type of component necessary for the functionality of the controller 600.

In some embodiments, the controller 600 is designed and configured to electronically control various assemblies and/or elements of the system 10, such as, without limitation, the ozone assembly 1100, the negative ion assembly 1000, the fan assembly 500 (if included), the valve assembly 200 (if electronic), the power source 700, other elements of the system 10 that may benefit from being electronically controlled, and any combinations thereof.

Power Source 700 (Waterpipe Unit)

In some embodiments, the power source 700 includes any type of adequate power source to power the various electronic assemblies and/or elements of the system 10, such as, without limitation, the ozone assembly 1100, the negative ion assembly 1000, the fan assembly 500 (if included), the valve assembly 200 (if electronic), the controller 600, other elements of the system 10 that may benefit from being powered, and any combinations thereof.

In some embodiments, the power source 700 includes a rechargeable power source (e.g., a rechargeable battery or rechargeable battery pack) so that the power source 700 may be plugged into an external recharging device (e.g., an electrical wall outlet) to be recharged.

In some embodiments, the power source 700 is removable and may be replaced as necessary.

It is understood that the power source 700 may include any adequate power source adapted to adequately power the assemblies and elements of the system 10 that would benefit from being powered.

Housing Assembly 800 (Waterpipe Unit)

In some embodiments, as shown in FIG. 4, the housing assembly 800 includes an outer casing defining an inner volume adapted to receive, house, and secure the various assemblies and elements of the system 10.

In some embodiments, the housing assembly 800 includes one or more internal cavities, with each internal cavity designed to receive and house a particular assembly or element of the system 10.

In some embodiments, the housing assembly 800 may open to allow access to at least some of the assemblies and/or elements of the system 10 so that the assemblies and/or elements may be removed, maintained, cleaned, and/or replaced. In this way, the system 10 is modular. For example, in some embodiments, an upper portion of the housing assembly 800 may be removable (and/or pivotable away from the housing) to allow access to the filter assembly 900, the ozone assembly 1100, and/or the negative ion assembly 1000, as these assemblies may require maintenance, cleaning, removal, replacement, etc.

In some embodiments, the filter compartment 903 and the smoke processing chamber 402 may be combined into a single chamber.

In Use (Waterpipe Unit)

To use the system 10, a user and/or the system 10 may take at least some of the following actions:

The user inserts a smokeable material M (e.g., cannabis flower) into the combustion compartment bowl piece 118.

The user ignites the smokable material M and inhales the resulting smoke through the mouthpiece assembly 300.

Simultaneously or prior to the user's inhalation, the user and/or the system 10 configures the valve assembly 200 to activate the (2)-(1) path. Note that this may or may not require manual intervention from the user depending on the type of valve assembly 200 utilized as described herein.

Smoke from the combustion assembly 100 passes through the valve assembly 200 and the mouthpiece assembly 300 and into the user's lungs.

The user exhales smoke into mouthpiece assembly 300.

Simultaneously or prior to the user's exhalation, the user and/or the system 10 configures the valve assembly 200 to activate the (1)-(3) path. Note that this may or may not require manual intervention from the user depending on the type of valve assembly 200 utilized as described herein.

Exhaled smoke passes into and through the smoke processing assembly 400 and is processed as described herein and discharged out of the system 10 via the vents 404.

It is understood that the actions described above are meant for demonstration and that not all of the action may be required, that other actions may be taken, and that the actions may be taken in different order.

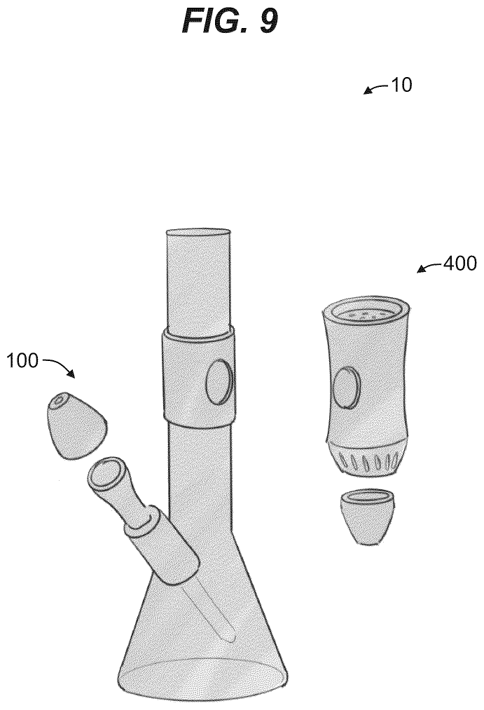

FIGS. 9-14 show alternative embodiments of the reduced odor smoking system 10 according to exemplary embodiments hereof.

FIG. 9 shows and embodiment of the reduced odor smoking system 10 including a removable smoke processing assembly 400. The smoke processing assembly 400 is attachable to the combustion assembly 100 and removable when needed for use. During use, the user inhales smoke through the combustion assembly 100, removes the smoke processing assembly 400, and exhales into the input of the smoke processing assembly 400. This embodiment also includes a cap for the bowl piece 118 and the smoke processing system 400.

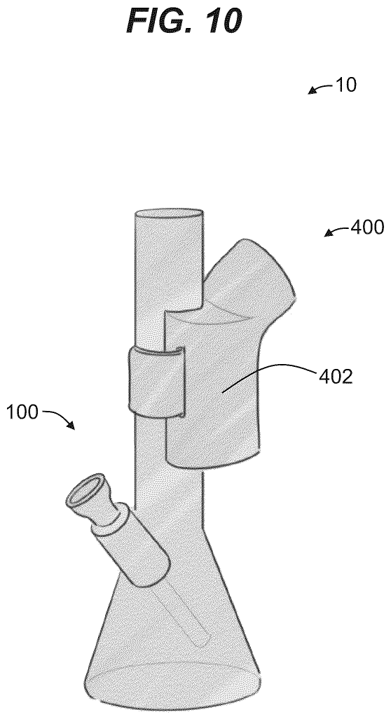

FIG. 10 shows an embodiment of the system 10 including a separate smoke processing system 400 attached to the side of the combustion assembly 100. During use, the user inhales smoke through the combustion assembly 100, and exhales into the input of the smoke processing assembly 400.

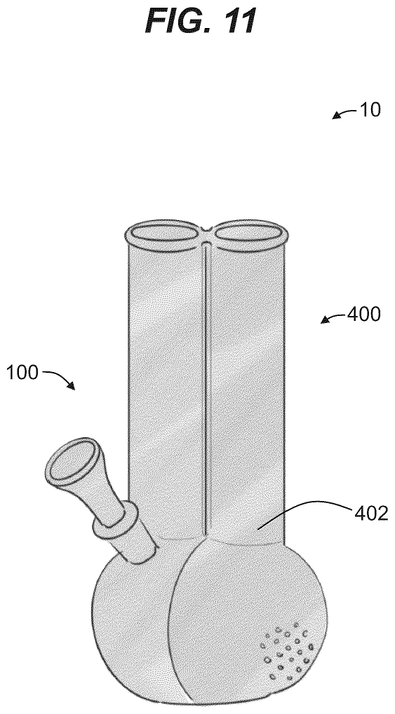

FIG. 11 shows an embodiment of the system 10 including a separate smoke processing system 400 attached to the side of the combustion assembly 100. During use, the user inhales smoke through the combustion assembly 100, and exhales into the input of the smoke processing assembly 400. In this embodiment, the smoke processing assembly 400 resembles the look and feel of the combustion assembly 100.

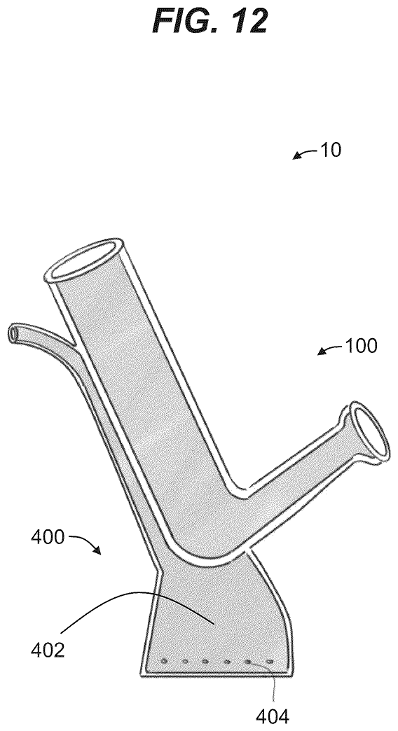

FIG. 12 shows an embodiment of the system 10 including a separate smoke processing system 400 attached to the side of the combustion assembly 100. During use, the user inhales smoke through the combustion assembly 100, and exhales into the input of the smoke processing assembly 400. In this embodiment, the smoke processing chamber 402 is generally below the combustion assembly 100 and provides a base to the assembly 100.

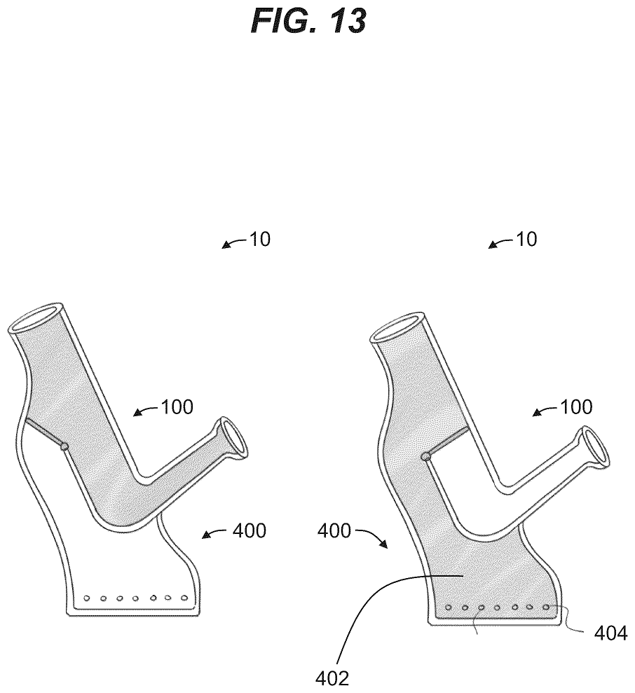

FIG. 13 shows an embodiment of the system 10 including an internal valve assembly 200 that directs the smoke from the combustion assembly 100 to the mouthpiece 300, and from the mouthpiece 300 to the smoke processing assembly 400. In this embodiment, the smoke processing chamber 402 is generally below the combustion assembly 100 and provides a base to the assembly 100.

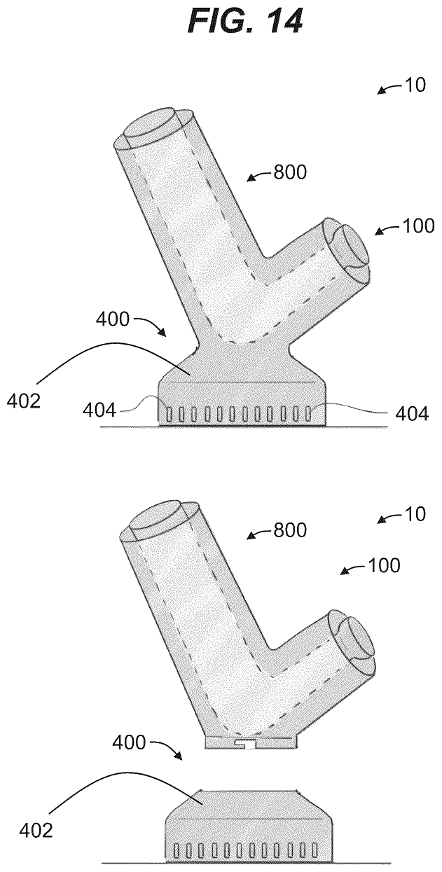

FIG. 14 shows and embodiment of the system 10 including a combustion assembly 100 generally enclosed within the housing 800 and the smoke processing chamber 402 positioned generally below the combustion assembly 100. In addition, the smoke processing chamber 402 (and the smoke processing assembly 400) may be detached from the water pipe combustion assembly 100 as shown.

It is understood that any aspect and/or element of any embodiment of the system 10 described herein or otherwise may be combined with any other aspect and/or element of any other embodiment described herein or otherwise in any way to form additional embodiments of the system 10 all of which are within the scope of the system 10.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “Including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

What is claimed is:

1. A smoking system comprising:
a housing including a first housing side;
a holder within the housing and for holding a smokable material;
a mouthpiece;
a first outlet in the first housing side and a second outlet in the first housing side;
a fan aligned directly behind the first outlet;
a smoke processing system within the housing and including a smoke filter assembly and an ozone generator, the ozone generator including an ozone emitter aligned directly behind the second outlet and adapted to release ozone out of the second outlet; and
a valve assembly providing a first one-way fluid passageway between the holder and the mouthpiece, and a second one-way fluid passageway between the mouthpiece and the smoke processing system;
wherein the fan and the first outlet are separated from the ozone emitter and the second outlet by a partition within the housing.

2. The smoking system of claim 1 wherein the valve assembly includes a first one-way valve to provide the first one-way passageway and a second one-way valve to provide the second one-way passageway.

3. (canceled)

4. The smoking system of claim 3 wherein the smoke filter assembly includes one or more layers of smoke filtering materials.

5. The smoking system of claim 4 wherein the one or more layers of smoke filtering materials include at least one of cotton, cellulose acetate, paper, rayon, hemp, corn husk, and foam.

6. The smoking system of claim 1 wherein the smoke processing system includes a negative ion generator.

7. The smoking system of claim 6 wherein the smoke processing system includes a smoke processing chamber, and the negative ion generator is positioned to release negative ions into the smoke processing chamber.

8. (canceled)

9. The smoking system of claim 1 wherein the smoke processing system includes a smoke processing chamber, and the ozone generator is positioned to release ozone into the smoke processing chamber.

10. (canceled)

11. (canceled)

12. The smoking system of claim 1 further comprising:
an ignition device configured with the holder and positioned to ignite the smokable material.

13. The smoking system of claim 12 further comprising a tension mechanism configured to hold the ignition device in physical contact with the smokable material.

14. The smoking system of claim 13 wherein the tension mechanism includes a spring.

15.-16. (canceled)

17. The smoking system of claim 1 wherein the smokable material includes a smokable rod including a mouth end and an ignition end, the smoking system further comprising:
a support member configured with the holder including an aperture configured to receive the mouth end of the smokable rod;
wherein the support member is removable from the housing to facilitate the reception of the mouth end of the smokable rod.

18. The smoking system of claim 1 further comprising a power supply to provide power to the smoke processing system.

19. The smoking system of claim 1 wherein the first and second outlets are separated by a gap defined by a solid portion of the first housing side.

20. The smoking system of claim 1 wherein a flow of ozone emitted from the ozone emitter out of the second outlet is independent of an airflow induced by the fan out of the first outlet.

21. The smoking system of claim 1 wherein a flow of ozone emitted from the ozone emitter is unobstructed between the ozone emitter and the second outlet.

22. A smoking system comprising:
a housing including a first housing side;
a holder within the housing and for holding a smokable material;
a mouthpiece;
a first outlet in the first housing side and a second outlet in the first housing side;
a fan aligned directly behind the first outlet;
a smoke processing system within the housing and including a smoke filter assembly and an ozone generator, the ozone generator including an ozone emitter aligned directly behind the second outlet and adapted to release ozone out of the second outlet; and
a valve assembly providing a first one-way fluid passageway between the holder and the mouthpiece, and a second one-way fluid passageway between the mouthpiece and the smoke processing system;
wherein a flow of ozone emitted from the ozone emitter out of the second outlet is independent of an airflow induced by the fan out of the first outlet.

23. The smoking system of claim 22 wherein the fan and the first outlet are separated from the ozone emitter and the second outlet by a partition within the housing.

24. The smoking system of claim 22 wherein the smoke processing system includes a negative ion generator.

25. The smoking system of claim 1 further comprising:
an ignition device configured with the holder and positioned to ignite the smokable material.
